(19) United States
(12) Patent Application Publication
(10) Pub. No.: US 2025/0091335 A1
(43) Pub. Date: Mar. 20, 2025

(54) FIRE AND SLIP RESISTANT ARTICLES

(71) Applicant: 3M INNOVATIVE PROPERTIES COMPANY, St. Paul, MN (US)

(72) Inventors: John E. Gozum, Stillwater, MN (US); Denis Terzic, Arden Hills, MN (US)

(21) Appl. No.: 18/729,304

(22) PCT Filed: Feb. 9, 2023
(86) PCT No.: PCT/IB2023/051182

§ 371 Date: Jul. 16, 2024

Related U.S. Application Data
(60) Provisional application No. 63/308,704, filed on Feb. 10, 2022.

(51) Int. Cl. B32B 27/18; B32B 3/30; B32B 7/12; B32B 27/08; B32B 27/32; B32B 27/36

(52) U.S. Cl. CPC B32B 27/18; B32B 3/30; B32B 7/12; B32B 27/08; B32B 27/32; B32B 27/36; B32B 2255/10; B32B 2255/26; B32B 2307/3065; B32B 2307/4026; B32B 2307/744; B32B 2471/00

(57) ABSTRACT

A slip-resistant article includes a traction layer, a substrate layer, and an adhesive layer. The traction layer includes a polyolefin resin and a halogen-free flame retardant and has a first major surface with static coefficient of friction greater than or equal to 0.6.

The present disclosure relates to slip-resistance articles and, in particular, slip-resistant tapes or treads.

Slip resistant tapes and treads are frequently placed on slip-prone surfaces, in order to improve safety and reduce the incidence of slip and fall-type accidents, especially in the transportation industry. Slip resistant tapes and treads typically include adhesive-backed tapes or sheets. They may be placed, for example, on stair treads or wet areas, to decrease the incidence of a person slipping. As such, they can have an important role in residential and workplace safety.

### SUMMARY

The present disclosure relates to a slip-resistant article that surprisingly provides a slip-resistant and fire-resistant article that is also halogen-free.

In one aspect, a slip-resistant article includes a traction layer includes polyolefin resin and a halogen-free flame retardant and having a first major surface with static coefficient of friction greater than or equal to 0.6, a substrate layer coupled to a second major surface of the traction layer, and an adhesive layer coupled to the substrate layer opposite to the traction layer.

### BRIEF DESCRIPTION OF THE DRAWINGS

FIG. 1 illustrates a perspective view of an environment including a slip-resistant article.

FIG. 2 illustrates a cross-sectional view of the slip-resistant article of FIG. 1.

### DETAILED DESCRIPTION

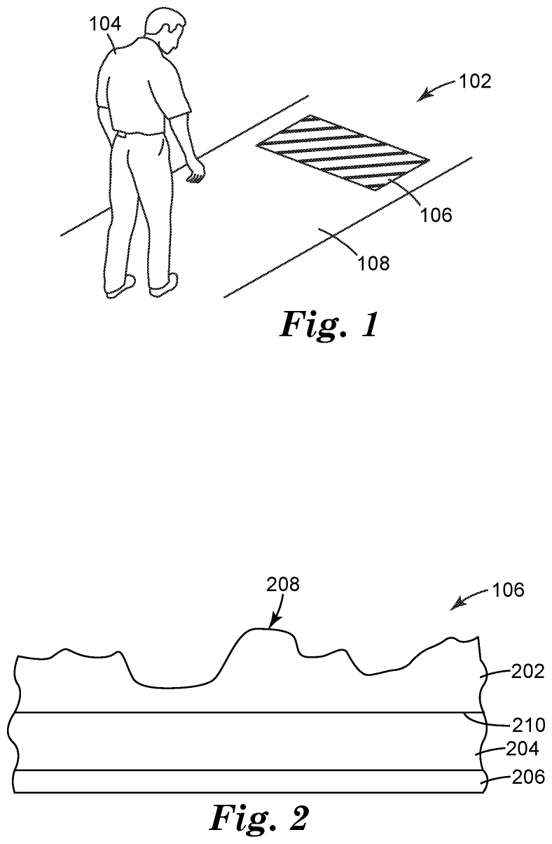

FIG. 1 is a drawing of an environment 102 including a slip-resistant article 106 and a person 104 on a floor 108. In environment 102, person 104 is seen walking along the floor 108. In some embodiments, the slip-resistant article 106 is used as a traction tape or a traction tread. Slip-resistant article 106 has a slip-resistant top, exposed surface, with a sufficient static coefficient of friction to reduce the chance of person 104 slipping when he or she steps on slip-resistant article 106. Though shown as placed before the first step in environment 102, in practice slip-resistant article 106 may be placed on each stair tread, or wherever desired to reduce the chance of slippage by persons.

In general, the slip-resistant article 106 is substantially planar to provide a major surface serving as a traction surface, which may also be described as an anti-slip, friction, or slip-resistance surface. The slip-resistant article 106 may be flexible, especially when used as a traction tape. Flexibility allows for the slip-resistant article 106 to be applied to irregular or uneven surfaces and may be wrapped around a core and sold as a roll to facilitate easy transportation. “Flexibility” or being flexible refers to the ability of an article to be wrapped around a core having a diameter as small as 3 inches while maintaining functional properties. Then, when purchased by an end user, the slip-resistant article 106 may be released from the core, optionally cut, and applied to various surfaces, which may or may not be substantially planar, such as a floor. Treads, or mats, are often flexible as well. Treads are often supplied in the form of a sheet. Tapes are often supplied in the form of a roll.

The slip-resistant article 106 may be sufficiently thin to facilitate a low-profile and may facilitate flexibility. In some embodiments, the slip-resistant article 106 may have a thickness between 0.5 and 5 millimeters (mm), such as about 1 millimeter.

The slip-resistant article 106 also has fire resistance. Fire resistance may be useful in applications where low flammability is important, such as some transportation applications. Some jurisdictions may even require low flammability in certain application. The slip-resistant article 106 includes a flame retardant to impart fire resistance. In some embodiments, the fire resistance is imparted without including certain flame retardants including halogens, heavy metal, or even metal hydroxides in the slip-resistant article. In some embodiments, the flame retardant is a halogen-free flame retardant that includes one or more of ammonium polyphosphate, melamine, and poly alcohol, which may have superior fire resistance compared to some aforementioned certain flame retardants as described herein in more detail.

FIG. 2 is a cross-sectional drawing of the slip-resistant article 106 having a traction layer 202, a substrate layer 204, and an adhesive layer 206. In the illustrated embodiment, the traction layer 202 has a first major surface 208 and a second major surface 210 opposite to the first major surface. The substrate layer 204 is coupled to the second major surface 210 of the traction layer 202. The adhesive layer 206 is coupled to the substrate layer 204 opposite to the traction layer 202.

The slip-resistance of the slip-resistant article 106 may be characterized in the static coefficient of friction of the first major surface 208, which is exposed to pedestrians. The first major surface 208 may be described as being a high-traction surface having a high static coefficient of friction. As used herein, a “high-traction surface” refers to a surface having a static coefficient of friction of at least 0.6. In some embodiments, the static coefficient of friction of the first major surface 208 may be greater than or equal to 0.6, 0.75, 0.8, 0.85, 0.9, or even 0.95.

The high static coefficient of friction may be imparted using one or more techniques, such as using a non-slip material in the traction layer 202, imparting a textured surface in the first major surface 208, or using anti-slip materials (such as minerals or rubber-like materials) in the traction layer 202 to at least partially form the first major surface 208. Using two or more techniques may impart more traction, or friction, properties than using only one technique.

In some embodiments, the traction layer 202 may include a non-slip material that at least partially forms the first major surface 208. “Non-slip material” refers to material that, when used to provide a substantially planar surface, has a static coefficient of friction of at least 0.6 without using the other techniques, such as texturing or anti-slip materials. In some embodiments, the static coefficient of friction of such a substantially planar surface made of non-slip material may be greater than or equal to 0.6, 0.75, 0.8, 0.85, 0.9, or even 0.95.

### Other Techniques

In general, the non-slip material includes a polyolefin resin. The polyolefin resin may include one or both of polyoctene and polyethylene. The polyoctene may be blended with the polyethylene.

The polyolefin resin may include a copolymer. A non-limiting example of a suitable copolymer includes ENGAGE 8150 polyolefin elastomer commercially available from Dow Chemical Company (Midland, Michigan), which is an ethylene-octene copolymer. Such elastomer including a polyoctene copolymer may be blended with polyethylene to provide the polyolefin resin.

In some embodiments, polyethylene may included in the form of linear low-density polyethylene (LLDPE). A non-limiting example of a suitable LLDPE includes DNDA-8335 NT 7 LLDPE resin commercially available from Dow Chemical Company (Midland, Michigan).

The non-slip material may also be selected for its performance in typical conditions of an application. In some embodiments, the non-slip material may be selected for having a high static coefficient of friction even when exposed to water moisture, or not being completely dried out.

In general, the traction layer 202 is made of a fire-resistant material. The non-slip material also includes a halogen-free flame retardant to impart fire resistance properties into the traction layer 202. The flame retardant may be described as an intumescent combination based on ammonium polyphosphate. In some embodiments, the intumescent combination may have about 40-60% ammonium polyphosphate and about 10-30% melamine. In one example, the flame retardant includes BUDIT 669S flame retardant commercially available from Budenheim USA (Mansfield, Ohio).

The flame retardant may be present in any amount that provides a suitable combination of fire resistance and slip resistance. In some embodiments, the flame retardant is greater than or equal to 20%, 25%, 30%, 35%, 40%, or even 45% of the total weight of the traction layer 202. In some embodiments, the flame retardant is less than or equal to 55%, 50%, 45%, 40%, 35%, 30%, or even 25% of the total weight of the traction layer 202. For example, the flame retardant may be between 25% to 50%, 30% to 45%, or even 35% to 40% of the total weight of the traction layer.

The non-slip material may also include a synergist additive for use with the flame retardant. In one example, the synergist includes a melamine polymetalphosphate (zinc phosphate), such as a SAFIRE 400 additive commercially available from Huber Engineered Materials (Atlanta, Georgia).

In some embodiments, the first major surface 208 is a textured surface. The textured surface may be configured for particular applications. In some embodiments, the textured surface may be configured to be used on a floor for pedestrians that may not be wearing shoes, such as a passenger area or bathroom on a train. In one example, the textured surface may be configured as a pebble-like surface, which may be an irregular pebble-like surface, useful for areas for pedestrians without shoes or other areas where a smooth appearance and feeling are desired or acceptable. A pebble-like surface refers to a surface having a pebble-like pattern, which is an uneven and undulating surface having rounded features as opposed to sharp or jagged features. In some embodiments, a depth of the surface from a peak to an apex is between 50 micrometers and 1000 micrometers. As illustrated in FIG. 2, the first major surface 208 has a pebbled surface. In another example (not shown), the textured surface may be jagged or include sharper edges, which may be useful for areas for pedestrians with shoes or other areas where a rough appearance and feeling are desired or acceptable.

The substrate layer 204 may be formed of any suitable material. In general, the substrate layer 204 is made of a fire-resistant material. The substrate layer 204 may be formed of a polymer film, such as polyester film. A polyester film may include a primer layer in an appropriate amount to facilitate adhesion to the adhesive layer 206. Such a primer layer if included may be described as being part of the substrate layer 204.

The adhesive layer 206 may be formed of any suitable material. In general, the adhesive layer 206 is made of a fire-resistant material. In some embodiments, the adhesive layer 206 may include a pressure sensitive adhesive (PSA) material. The PSA material may include one or both of a copolymer rubber and a tackifier, which may used to form a tackified synthetic rubber. A tackifier may also be used to form a tackified natural rubber in the PSA material. A non-limiting example of a copolymer includes a clear, linear triblock copolymer based on styrene and isoprene, such as KRATON D1119 polymer commercially available from Kraton Polymers U.S. LLC (Houston, Texas). A non-limiting example of a tackifier includes an aliphatic hydrocarbon resin, such as ESCOREZ 1304 tackifying resin commercially available from ExxonMobil Chemical Company (Spring, Texas). In general, a synthetic or natural rubber, a tackifier, and an appropriate ratio between them may be selected by a person of ordinary skill in the art having the benefit of this disclosure to have appropriate PSA-related properties.

The slip-resistant article 106 may be formed using any suitable process. In one example, the traction layer 202 and substrate layer 204 may be pressed at a high temperature and pressure (e.g., at about 149° C. and 34.5 Megapascal). The resulting multilayer film may be coated by an adhesive to form the adhesive layer 206 on the substrate layer 204.

### EXAMPLES

Unless Otherwise Noted or Readily Apparent from the Context, all Parts, Percentages, ratios, etc. in the Examples and the rest of the specification are by weight.

### Materials Used in the Examples

| Abbreviation | Description and Source |
|---|---|
| Primed Polyester | PET primed with an acrylate copolymer |
| Film | (total thickness 3.2 mil and the primer |
| | is about 10% or less the total thickness) |
| 8335 NT 7 | DDNA-8335 NT 7 product, a linear low |
| Polyethylene | density polyethylene resin, commercially |
| | available from Dow Chemical Company |
| | (Midland, Michigan) |
| Engage 8150 | ENGAGE 8150 product, a polyolefin |
| | elastomer, commercially available |
| | from Dow Chemical Company |
| | (Midland, Michigan) |
| Black Pigment | Carbon Black Pigment Concentrate |
| | 1000108P commercially available from |
| | Clariant (West Chicago, Illinois) |
| Cros S10 flame | FR CROS S10 product, a flame retardant |
| retardant | including ammonium polyphosphate, |
| | by Chemische Fabrik Budenheim KG |
| | commercially available from Budenheim |
| | USA (Mansfield, Ohio) |
| Safire flame | SAFIRE 400 product, a flame retardant |
| retardant | including melamine-poly(zinc phosphate), |
| | commercially available from Huber |
| | Engineered Materials (Atlanta, Georgia) |
| Budit flame | BUDIT 669S product, a halogen-free flame |
| retardant | retardant including ammonium polyphosphate, |
| | commercially available from |
| | Budenheim USA (Mansfield, Ohio) |
| ATH flame | SB-432 product, an alumina trihydrate, |
| retardant | commercially available from Huber |
| | Engineered Materials (Atlanta, Georgia) |
| MDH flame | MAGNIFIN H-5 product, a magnesium |
| retardant | hydroxide, commercially available from |
| | Huber Engineered Materials (Atlanta, Georgia) |
| Kraton D1119 | D1119 product, a linear triblock copolymer, |
| | commercially available from Kraton |
| | Corporation (Houston, Texas) |
| Escorez 1304 | ESCOREZ 1304 product, a tackifying resin, |
| | commercially available from ExxonMobil |
| | Chemical Company (Spring, Texas) |
| SW310 | 3M Safety Walk 310 product, a slip-resistant |
| | tape and tread, commercially available |
| | from 3M Company (St. Paul, Minnesota) |

### Radiant Panel Test Method

The Radiant Panel Test Method included individually testing a series of samples with either varying levels of active flame-retardant materials or a constant level of active flame-retardant materials and varying the ratio of 8335 NT 7 polyethene and Engage 8150 in the samples.

The radiant panel test method is a measure of relative flammability performance assessed by material flame spread. A radiant panel test chamber (Govmark Model FRP-1A-AI(E) 208V 3P 30 commercially available from SGS Govmark Testing Services, Inc., Farmingdale, NY, USA) was used to test the sample panels. Within the sample chamber, four fire bricks were placed to support a sample panel about the edge of the panel. The sample panel includes a 280 mm by 70 mm aluminum panel, 0.64 mm thick, with a 152 mm by 25 mm sample adhered to the panel with the sample centered on the panel and with a short edge of the sample flush with a short edge of the panel. The panel with the adhered sample may be aged between 5 and 7 days at either 20° C. or 65.5° C.

A sample panel was placed on the fire bricks and positioned so one end of the sample is proximate the pilot flame. The test chamber is heated to 370° C. The pilot flame was impinged on the short edge of the sample for a complete 95 seconds using the automated flame applicator of the chamber, and if no sustained ignition occurred within this period, a second 95 second application was performed. Samples that did not ignite were indicated in tables as DNI. Samples were allowed to burn until self-extinguished. The burn distance, or distance of flame travel lengthwise across the sample panel was then measured in millimeters. The lengthwise distance traversed of any molten liquified polyolefin mixture, was measured in millimeters and reported as melt distance. In some cases, both burn and melt distance exceed the original sample dimensions. The time between impingement of the pilot flame and sustained burning of the sample, as observed by the presence of a secondary flame, was measured in seconds and reported as ignition time. The time from impingement of the pilot flame until self-extinguishment of the flaming samples was measured in seconds and reported as burn time.

### Coefficient of Friction Test Method

The coefficient of friction was calculated from measurements using a James Machine (commercially available from Michelman, Inc., Cincinnati, Ohio). The James Machine uses ASTM D2047-17 standards to measure and calculate the coefficient of friction for floor samples. The test used a properly conditioned leather contact pad. While the ASTM standard is for measuring the coefficient of friction for polished floors, the samples are designed for floor applications and have at least a coefficient of friction greater than 0.6. Test samples were affixed to a 12″×12″ Vinyl Composite tile for testing using the adhesive described below. The tests were conducted as per the directions posted in the 2019 James Machine Operation Series D guide.

### Preparatory Examples

The samples were produced in a laboratory Brabender Mixer (commercially available from Brabender GmbH & Co. KG, Duisburg, Germany) on a 60-gram scale. The samples were compounded at 148.9° C. for 15-20 minutes. The control formulation can be found in Table 1. The samples were pressed at 148.9° C. and 5,000 psi to a thickness of approximately 40 mil onto a Primed Polyester Film. The samples were coated with the PSA with 55.1% by mass of Kraton D1119 and 44.9% by mass of Escorez 1304 as a 50% solution in toluene at a wet coating thickness of 30 mil.

TABLE 1
Formulation by percentage (%) and batch weight (g)

| Sample | 8335 NT 7 | | Black | Flame |
|---|---|---|---|---|
| Type | Polyethylene | Engage 8150 | Pigment | Retardant |
| 1 | 34.1% 20.43 g | 63.0% 37.80 g | 2.9% 1.77 g | Control |
| | | | | (0% 0 g) |
| 2 | 32.3% 19.40 g | 59.9% 35.91 g | 2.8% 1.68 g | Cros S10 |
| | | | | (5% 3 g) |
| 3 | 30.6% 18.38 g | 56.7% 34.02 g | 2.7% 1.59 g | Cros S10 |
| | | | | (10% 6 g) |
| 4 | 28.9% 17.36 g | 53.6% 32.13 g | 2.5% 1.51 g | Cros S10 |
| | | | | (15% 9 g) |
| 5 | 27.2% 16.34 g | 50.4% 30.24 g | 2.4% 1.42 g | Cros S10 |
| | | | | (15% 9 g) |
| | | | | Safire (5% 3 g) |
| 6 | 22.1% 13.28 g | 41.0% 24.57 g | 1.9% 1.15 g | Budit |
| | | | | (30% 18 g) |
| | | | | Safire (5% 3 g) |
| 7 | 20.4% 12.26 g | 37.8% 22.68 g | 1.8% 1.06 g | ATH |
| | | | | (40% 24 g) |
| 8 | 13.6% 8.17 g | 25.2% 15.12 g | 1.2% 0.71 g | ATH |
| | | | | (60% 36 g) |
| 9 | 20.4% 12.25 g | 37.8% 22.68 g | 1.8% 1.06 g | MDH |
| | | | | (40% 24 g) |
| 10 | 13.6% 8.17 g | 25.2% 15.12 g | 1.2% 0.71 g | MDH |
| | | | | (60% 36 g) |
| 11 | 20.4% 12.26 g | 37.8% 22.68 g | 1.8% 1.06 g | Budit |
| | | | | (40% 24 g) |
| 12 | 22.1% 13.27 g | 41.0% 24.57 g | 1.9% 1.15 g | Budit |
| | | | | (35% 21 g) |
| 13 | 23.8% 14.30 g | 44.1% 26.46 g | 2.1% 1.24 g | Budit |
| | | | | (30% 18 g) |
| 14 | 25.5% 15.32 g | 47.3% 28.35 g | 2.2% 1.33 g | Budit |
| | | | | (25% 15 g) |
| 15 | 27.2% 16.34 g | 50.4% 30.24 g | 2.4% 1.42 g | Budit |
| | | | | (20% 12 g) |
| 16 | 28.9% 17.36 g | 53.6% 32.13 g | 2.5% 1.50 g | Budit |
| | | | | (15% 9 g) |
| 17 | 30.6% 18.39 g | 56.7% 34.02 g | 2.7% 1.59 g | Budit |
| | | | | (10% 6 g) |
| 18 | 51.4% 30.87 g | 16.4% 9.87 g | 2.1% 1.26 g | Budit 73/23 |
| | | | | (30% 18 g) |
| 19 | 44.1% 26.46 g | 23.8% 14.28 g | 2.1% 1.26 g | Budit 63/34 |
| | | | | (30% 18 g) |
| 20 | 34.0% 20.37 g | 34.0% 20.37 g | 2.1% 1.26 g | Budit 50/50 |
| | | | | (30% 18 g) |
| 21 | 16.4% 9.87 g | 51.4% 30.87 g | 2.1% 1.26 g | Budit 23/73 |
| | | | | (30% 18 g) |

### Examples 1-3

### Example 1—Radiant Panel Test of Budit Samples with Varied Flame-Retardant Loading

Samples including Budit as a flame retardant (17, 16, 15, 14, 13, 12, 11, and 6) were tested for melt distance and burn distance using the Radiant Panel Test Method. Sample 1 was included as a control. Two sets of samples were tested, a set of samples aged at 20° C. and a set of samples aged at 65° C. Table 2. includes results from testing where the burn and melt distance for both aged sample sets significantly decreases with Budit loading of at least 20%.

TABLE 2
Example 1—Budit Radiant Panel Test Results by % Flame-Retardant Loading (FRL)

| | | Aged Sample Panel—20° C. | | | | Aged Sample Panel—65.5° C. | | | |
|---|---|---|---|---|---|---|---|---|---|
| | | Melt | Burn | Ignition | Burn | Melt | Burn | Ignition | Burn |
| FRL | Sample | Distance | Distance | Time | Time | Distance | Distance | Time | Time |
| (%) | # | (mm) | (mm) | (sec) | (sec) | (mm) | (mm) | (sec) | (sec) |
| 0 | 1 | 280 | 280 | 68 | 368 | 280 | 280 | 68 | 368 |
| 10 | 17 | 190 | 190 | 32 | 276 | 205 | 205 | 50 | 265 |
| 15 | 16 | 179 | 179 | 40 | 297 | 172 | 172 | 64 | 283 |
| 20 | 15 | 76 | 76 | 48 | 114 | 97 | 97 | 40 | 200 |
| 25 | 14 | 22 | 33 | 56 | 14 | 20 | 26 | 60 | 2 |
| 30 | 13 | 15 | 46 | DNI | 0 | 14 | 35 | 75 | 15 |
| 35 | 12 | 19 | 30 | DNI | 0 | 12 | 24 | DNI | 0 |
| 40 | 11, 6 | 15, 14 | 33, 28 | DNI, | 0, 0 | 14, 12 | 29, 23 | DNI, | 0, 0 |
| | | | | DNI | | | | DNI | |

### Example 2—Radiant Panel Test of Budit Samples with Varied PE to Engage 8150 Ratio

Samples including 30% Budit loading with a varied ratio of 8335 NT 7 polyethylene and Engage 8150 (18, 13, 19, 20, 21) were tested for melt distance and burn distance using the Radiant Test Method. Two sets of samples were tested, a set of samples aged at 20° C. and a set of samples aged at 65° C. Table 3. includes results from testing where the burn and melt distance do not vary with a ratio between 0.54 and 3.12. Sample 18 did ignite with a burn distance comparable to samples 13, 19, 20, and 21, but because it ignited, the burn time was greater than the other samples in Table 3.

TABLE 3
Example 2—Budit Radiant Panel Test Results at 30% Flame-Retardant Loading (FRL)

| PE to | | Aged Sample Panel—20° C. | | | | Aged Sample Panel—65.5° C. | | | |
|---|---|---|---|---|---|---|---|---|---|
| Engage | | Melt | Burn | Ignition | Burn | Melt | Burn | Ignition | Burn |
| 8150 | Sample | Distance | Distance | Time | Time | Distance | Distance | Time | Time |
| Ratio | # | (mm) | (mm) | (sec) | (sec) | (mm) | (mm) | (sec) | (sec) |
| 0.32 | 18 | 22 | 27 | 68 | 368 | 26 | 43 | 68 | 368 |
| 0.54 | 13 | 15 | 46 | DNI | 0 | 14 | 35 | DNI | 0 |
| 1 | 19 | 13 | 28 | DNI | 0 | 20 | 29 | DNI | 0 |
| 1.85 | 20 | 17 | 27 | DNI | 0 | 31 | 31 | DNI | 0 |
| 3.12 | 21 | 15 | 38 | DNI | 0 | 16 | 22 | DNI | 1 |

### Example 3—Budit Coefficient of Friction Test Results

Samples' coefficient of friction was determined using the Coefficient of Friction Test Method. This example shows that the invention has a similar or greater coefficient of friction than commercially available friction tapes (SW 310). Table 4 shows inventive samples have a similar or greater coefficient of friction than the control and SW 310.

TABLE 4
Example 3—Coefficient of Friction Measurements

| | Average Coefficient of |
|---|---|
| Sample | Friction |
| 1 | 0.78 |
| 17 | 0.81 |
| 16 | 0.79 |
| 14 | 0.79 |
| 13 | 0.84 |
| 11 | 0.74 |

### Comparative Examples 1-3

### Comparative Example 1—Radiant Panel Test of Cros S10 Samples with Varied Flame-Retardant Loading

Comparative samples including a Cros S10 as a flame retardant (2, 3, 4, and 5) were tested for melt distance and burn distance using the Radiant Panel Test Method. Sample 1 was included as a control. Two sets of samples were tested, a set of samples aged at 20° C. and a set of samples aged at 65° C. Table 5. includes results from testing where the burn and melt distance for both aged-sample sets decrease with Cros S10 loading of at least 10%. The inventive samples from Table 2 and 3 have a shorter melt and burn distance for a comparable flame-retardant loading percentage in Table 5, especially for samples aged at 20° C. where moisture and other factors reduce the efficacy of Cros S10.

TABLE 5
Comparative Example 1—Cros S10 Radiant Panel Test Results by %
Flame-Retardant Loading (FRL)

| | | Aged Sample Panel—20° C. | | | | Aged Sample Panel—65.5° C. | | | |
|---|---|---|---|---|---|---|---|---|---|
| | | Melt | Burn | Ignition | Burn | Melt | Burn | Ignition | Burn |
| FRL | Sample | Distance | Distance | Time | Time | Distance | Distance | Time | Time |
| (%) | # | (mm) | (mm) | (sec) | (sec) | (mm) | (mm) | (sec) | (sec) |
| 0 | 1 | 280 | 280 | 68 | 368 | 280 | 280 | 68 | 368 |
| 5 | 2 | 253 | 253 | 35 | 300 | 280 | 280 | 60 | 426 |
| 10 | 3 | 115 | 105 | 50 | 283 | 28 | 43 | 50 | 100 |
| 15 | 4 | 117 | 104 | 60 | 329 | 62 | 69 | 60 | 253 |
| 20 | 5 | 107 | 107 | 45 | 326 | 99 | 95 | 70 | 297 |

### Comparative Example 2—Radiant Panel Test of ATH Samples with Varied Flame-Retardant Loading

Comparative samples including ATH as a flame retardant (7 and 8) were tested for melt distance and burn distance using the Radiant Panel Test Method. Sample 1 was included as a control. Two sets of samples were tested, a set of samples aged at 20° C. and a set of samples aged at 65° C. Table 6. includes results from testing where the burn and melt distance for both aged-sample sets decrease with ATH loading of at least greater than 60%. The burn distance at 40% indicates an ineffective amount of flame retardant loading. The inventive samples from Table 2 and 3 have a shorter melt and burn distance for a comparable flame-retardant loading percentage in Table 6.

TABLE 6
Comparative Example 2—ATH Radiant Panel Test Results by % Flame-
Retardant Loading (FRL)

| | | Aged Sample Panel—20° C. | | | | Aged Sample Panel—65.5° C. | | | |
|---|---|---|---|---|---|---|---|---|---|
| | | Melt | Burn | Ignition | Burn | Melt | Burn | Ignition | Burn |
| FRL | Sample | Distance | Distance | Time | Time | Distance | Distance | Time | Time |
| (%) | # | (mm) | (mm) | (sec) | (sec) | (mm) | (mm) | (sec) | (sec) |
| 0 | 1 | 280 | 280 | 68 | 368 | 280 | 280 | 68 | 368 |
| 40 | 7 | 163 | 163 | 163 | 163 | 157 | 157 | 70 | 520 |
| 60 | 8 | 20 | 40 | 20 | 40 | 0 | 31 | DNI | 0 |

### Comparative Example 3—Radiant Panel Test of MDH Samples with Varied Flame-Retardant Loading

Comparative samples including MDH as flame retardant (9 and 10) were tested for melt distance and burn distance using the Radiant Panel Test Method. Sample 1 was included as a control. Two sets of samples were tested, a set of samples aged at 20° C. and a set of samples aged at 65° C. Table 7. includes results from testing where the burn and melt distance for both aged-sample sets decrease with MDH loading of at least greater than 60%. The burn distance at 40% indicates an ineffective amount of flame retardant loading. The inventive samples from Table 2 and 3 have a shorter melt and burn distance for a comparable flame-retardant loading percentage in Table 7.

TABLE 7
Comparative Example 3—MDH Radiant Panel Test Results by % Flame-
Retardant Loading (FRL)

| | | Aged Sample Panel—20° C. | | | | Aged Sample Panel—65.5° C. | | | |
|---|---|---|---|---|---|---|---|---|---|
| | | Melt | Burn | Ignition | Burn | Melt | Burn | Ignition | Burn |
| FRL | Sample | Distance | Distance | Time | Time | Distance | Distance | Time | Time |
| (%) | # | (mm) | (mm) | (sec) | (sec) | (mm) | (mm) | (sec) | (sec) |
| 0 | 1 | 280 | 280 | 68 | 368 | 280 | 280 | 68 | 368 |
| 40 | 9 | 0 | 154 | 0 | 154 | 156 | 156 | 60 | 713 |
| 60 | 10 | 0 | 25 | 0 | 25 | 0 | 18 | DNI | 0 |

Thus, various embodiments of FIRE AND SLIP RESISTANT ARTICLES are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

The term “or” is generally employed in its inclusive sense, for example, to mean “and/or” unless the context clearly dictates otherwise. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A slip-resistant article comprising:
a traction layer comprising polyolefin resin and a halogen-free flame retardant and having a first major surface with static coefficient of friction greater than or equal to 0.6;
a substrate layer coupled to a second major surface of the traction layer; and
an adhesive layer coupled to the substrate layer opposite to the traction layer.

2. The slip-resistant article of claim 1, wherein the first major surface comprises a textured surface.

3. The slip-resistant article of claim 1, wherein the textured surface has a pebble-like pattern.

4. The slip-resistant article of claim 1, wherein the flame retardant comprises one or more of ammonium polyphosphate, melamine, and a poly alcohol.

5. The slip-resistant article of claim 1, wherein the flame retardant is greater than or equal to 25% of the total weight of the traction layer.

6. The slip-resistant article of claim 5, wherein the flame retardant is less than or equal to 50% of the total weight of the traction layer.

7. The slip-resistant article of claim 1, wherein the polyolefin resin comprises linear low-density polyethylene.

8. The slip-resistant article of claim 1, wherein the substrate layer comprises a polyester film.

9. The slip-resistant article of claim 1, wherein the adhesive layer comprises a pressure sensitive adhesive material.

10. The slip-resistant article of claim 8, wherein the adhesive layer comprises tackified synthetic rubber.

11. The slip-resistant article of claim 1, wherein the static coefficient of friction is greater than or equal to 0.75.

12. The slip-resistant article of claim 1, wherein the slip-resistant article is flexible.

13. A floor comprising the slip-resistant article of claim 1.

14. A method comprising applying the slip-resistant article of claim 1 to a floor.
